(19) United States
(12) Patent Application Publication
(10) Pub. No.: US 2005/0137751 A1
(43) Pub. Date: Jun. 23, 2005

(54) Auto-diagnostic method and apparatus

(76) Inventors: Damon Keith Cox, Round Rock, TX (US); Marvin L. Freeman, Round Rock, TX (US)

Correspondence Address: MOSER, PATTERSON & SHERIDAN, LLP;APPLIED MATERIALS, INC., 3040 POST OAK BOULEVARD, SUITE 1500, HOUSTON, TX, 77056, US

(21) Appl. No.: 11/002,732

(22) Filed: Dec. 2, 2004

Related U.S. Application Data
(60) Provisional application No. 60/527,474, filed on Dec. 5, 2003.

(51) Int. Cl. G06F 19/00

(52) U.S. Cl. 700/245; 700/254

(57) ABSTRACT

Methods for automated calibration and diagnostics of a workpiece transfer system are provided. In one embodiment, a method for locating an end effector includes retrieving a workpiece located at a target location, passing the workpiece through a plurality of sensors, wherein at least one of the sensors changes state in response to a position of at least one of the end effector or workpiece, recording a metric of robot position associated with the sensor change of state, determining an error for an expected metric of the end effector position from the recorded robot position metric and correcting a taught location of the robot for the target position. In another embodiment, a process for monitoring a robotic transfer system is provided that includes detecting a first positional error in a robotic transfer system, and comparing the first positional error to a second positional error in the robotic transfer system.

### CROSS-REFERENCE TO RELATED APPLICATIONS

This patent application claims benefit of U.S. Provisional Patent Application Ser. No. 60/572,474, filed Dec. 5, 2003, which is hereby incorporated by reference in its entirety.

### BACKGROUND OF THE INVENTION

1. Field of the Invention

The embodiments of the invention generally relate to automated calibration and diagnostics of a workpiece transfer system.

2. Background of the Related Art

Semiconductor substrate processing is typically performed by subjecting a substrate to a plurality of sequential processes to create devices, conductors and insulators on the substrate. These processes are generally performed in a process chamber configured to perform a single step of the production process. In order to efficiently complete the entire sequence of processing steps, a number of process chambers are typically coupled to a central transfer chamber that houses a robot to facilitate transfer of the substrate between the surrounding process chambers. A semiconductor processing platform having this configuration is generally known as a cluster tool, examples of which are the families of PRODUCER®, CENTURA® and ENDURA® processing platforms available from Applied Materials, Inc., of Santa Clara, Calif.

Generally, a cluster tool consists of a central transfer chamber having a robot disposed therein. The transfer chamber is generally surrounded by one or more process chambers. The process chambers are generally utilized to process the substrate, for example, performing various processing steps such as etching, physical vapor deposition, ion implantation, lithography and the like. The transfer chamber is sometimes coupled to a factory interface that houses a plurality of removable cassettes, substrate storage, each of which houses a plurality of substrates. To facilitate transfer between a vacuum environment of the transfer chamber and a generally ambient environment of the factory interface, a load lock chamber is disposed between the transfer chamber and the factory interface.

As line width and feature sizes of devices formed on the substrate have decreased, the positional accuracy of the substrate in the various chambers surrounding the transfer chamber has become paramount to ensure repetitive device fabrication with low defect rates. Moreover, with the increased amount of devices formed on substrates both due to increased device density and larger substrate diameters, the value of each substrate has greatly increased. Accordingly, damage to the substrate or yield loss due to non-conformity because of substrate misalignment is highly undesirable.

A number of strategies have been employed in order to increase the positional accuracy of substrates throughout the processing system. For example, the interfaces are often equipped with sensors that detect substrate misalignment within the substrate storage cassette. See, U.S. patent application Ser. No. 09/562,252 filed May 2, 2000 by Chokshi, et al. Positional calibration of robots has become more sophisticated. See, U.S. Pat. No. 6,648,730 issued Nov. 18, 2003 to Chokshi, et al. Additionally, methods have been devised to compensate for substrate misplacement on the end effector of the robot. See, U.S. Pat. No. 5,980,194, issued Nov. 9, 1999 to Freerks, et al., and U.S. Pat. No. 4,944,650, issued Jul. 31, 1990 to T. Matsumoto. Methods have also been developed to compensate for thermal expansion and contraction experienced by the robot as heat is transferred to the robot from hot substrates and from hot surfaces within the process chambers. See, U.S. patent application Ser. No. 10/406,644, filed Apr. 3, 2003 by Freeman et al.

A fundamental principal in providing increased accuracy of substrate placement is the calibration process for teaching robot target positions (typically substrate handoff positions) of the robot's end effector. Most substrate handling robots are taught each handoff position manually. However, manual calibration relies on subjective skills of the operators and often must be performed with the systems chambers open to the FAB environment in order to allow the operator to adequately observe the target and end effector positions. If subsequent calibration is required, the processing system must again be opened, requiring cost and time consuming wipes and pump-down before production may resume.

Some machine vision systems supported on the end effector, such as described in U.S. Pat. No. 6,603,117 issued Aug. 5, 2003 to Corrado, et al., allow calibration to be performed under vacuum conditions. However, such systems require batteries, sensors and other electronic components that are not easily adapted for use in vacuum conditions or at elevated temperatures. These options also generally require complicated and significant programming for integration into existing robot motion code software, therefore making the cost of implementation undesirably high.

Therefore, there is a need for an improved method for determining a position of a robot and automatically diagnosing performance of the same.

### SUMMARY OF THE INVENTION

Methods for automated calibration and diagnostics of a workpiece transfer system are provided. It is contemplated that the calibration and diagnostic methods described herein may be adapted to benefit other robotic applications. In one embodiment, a method for locating an end effector of a robot includes retrieving a workpiece located at a target location with a robot end effector, passing the workpiece disposed on the end effector through a plurality of sensors, wherein at least one of the sensors changes state in response to a position of at least one of the end effector or workpiece, recording a metric of robot position associated with the sensor change of state, determining an error for an expected metric of the end effector position from the recorded robot position metric and correcting a taught location of the robot for the target position.

In another embodiment, a process for monitoring a robotic transfer system is provided that includes monitoring changes in positioning errors in a robotic transfer system. In yet another embodiment, a process for monitoring a robotic transfer system includes detecting a first positional error in a robotic transfer system, and comparing the first positional error to a second positional error in the robotic transfer system.

In another embodiment, a method for automated teaching of a robot disposed in a processing system having a sensor based, substrate centerfinder system is provided. In one embodiment, a method for teaching of a robot includes providing a substrate in a known position, transferring the substrate to an end effector of the robot, moving the substrate through a centerfinder, resolving a difference between the substrate center and an expected position of the end effector, and correcting the robot's motion.

In another embodiment, the invention includes locating the position of a robot end effector with respect to a target location, where a substrate located at the target location is retrieved and transported from the target location on a robot end effector, the location of a substrate with respect to the robot end effector is determined as the end effector passes the substrate through a plurality of sensors (e.g., centerfinder) during transport, the location of the end effector with respect to the sensors has been predetermined and the error between the center of the substrate and end effector is used to correct the taught location for the target from which the substrate was received

In another aspect of the invention, an apparatus for determining the position of a robot is provided. In one embodiment, the apparatus includes a robot, a substrate aligner, a centerfinder and a calibration substrate, wherein a calibration substrate is utilized to remove error that may be introduced while by the interaction between an end effect or of the robot and the substrate.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 is a plan view of one embodiment of a semiconductor processing system in which a method for determining a position of a robot may be practiced;

FIG. 2 is a partial sectional view of the processing system of FIG. 1;

FIG. 3 is a plan view of one embodiment of a semiconductor transfer robot;

FIG. 4 depicts one embodiment of a wrist of the robot of FIG. 3;

FIGS. 5A-C are flow diagrams methods for determining a position of a robot;

FIG. 6 is a schematic illustration of one embodiment of a method for placing a substrate in a predefined (e.g., known) position;

FIG. 7 is a sectional view of one embodiment of a centering lift ring;

FIG. 8 is a sectional view of one embodiment of a centering end effector;

FIG. 9 is a flow diagram of another embodiment of a method for determining a position (i.e., calibrating) of a robot;

FIG. 10 is a flow diagram of another embodiment of a method for determining a position (i.e., calibrating) of a robot;

FIG. 11 is a flow diagram of one embodiment of a method for reducing error when determining a position (i.e., calibrating) of a robot;

FIG. 12 is a flow diagram of another embodiment of a method for determining a position (i.e., calibrating) of a robot;

FIG. 13 is one embodiment of an auto-centering calibration wafer;

FIGS. 14A-B are examples of kinematic substrate alignment devices suitable for aligning a substrate in a predefined position;

FIGS. 14C-D are examples of passive substrate alignment devices suitable for aligning a substrate in a predefined position; and

FIG. 15 is another embodiment of calibration wafer;

It is to be noted, however, that the appended drawings illustrate only typical embodiments of this invention and are therefore not to be considered limiting of its scope, for the invention may admit to other equally effective embodiments.

### DETAILED DESCRIPTION

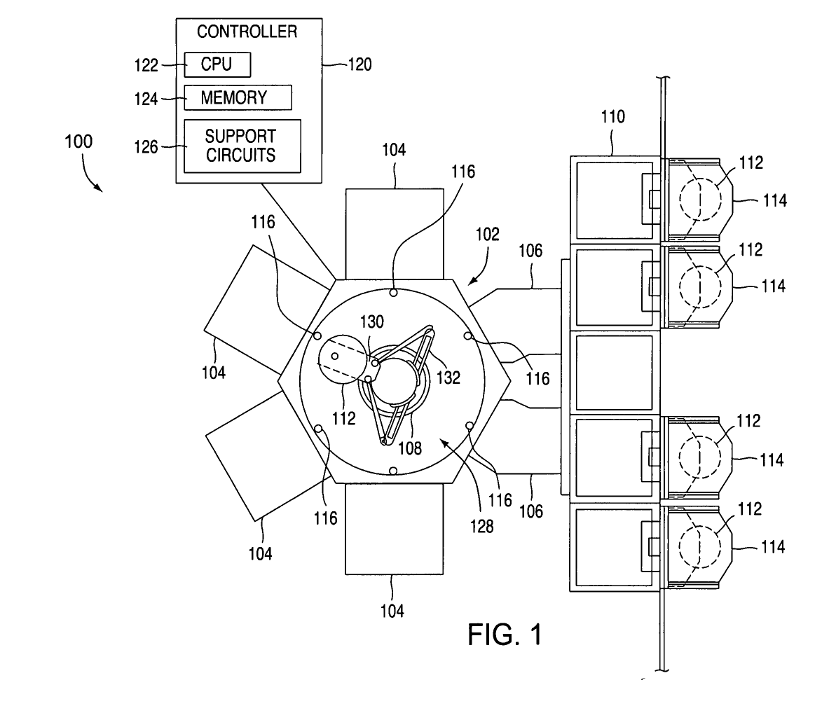

FIG. 1 depicts one embodiment of a semiconductor processing system 100 wherein a method for determining a position of a robot 108 may be practiced. The exemplary processing system 100 generally-includes a transfer chamber 102 circumscribed by one or more process chambers 104, a factory interface 110 and one or more load lock chambers 106. The load lock chambers 106 are generally disposed between the transfer chamber 102 and the factory interface 110 to facilitate substrate transfer between a vacuum environment maintained in the transfer chamber 102 and a substantially ambient environment maintained in the factory interface 110. One example of a processing system which may be adapted to benefit from the invention is a CENTURA® processing platform available from Applied Materials, Inc., of Santa Clara, Calif. Although the method for determining the position of a robot is described with reference to the exemplary processing system 100, the description is one of illustration and accordingly, the method may be practiced wherever the determination or position of a robot is desired in applications where the robot or the robot's components are exposed to changes in temperature or the reference position of the substrate transferred by the robot is desired.

The factory interface 110 generally houses one or more substrate storage cassettes 114. Each cassette 114 is configured to store a plurality of substrates therein. The factory interface 110 is generally maintained at or near atmospheric pressure. In one embodiment, filtered air is supplied to the factory interface 110 to minimize the concentration of particles within the factory interface and correspondingly substrate cleanliness. One example of a factory interface that may be adapted to benefit from the invention is described in U.S. patent application Ser. No. 09/161,970 filed Sep. 28, 1998 by Kroeker, which is hereby incorporated by reference in its entirety.

The transfer chamber 102 is generally fabricated from a single piece of material such as aluminum. The transfer chamber 102 defines an evacuable interior volume 128 through which substrates are transferred between the process chambers 104 coupled to the exterior of the transfer chamber 102. A pumping system (not shown) is coupled to the transfer chamber 102 through a port disposed on the chamber floor to maintain vacuum within the transfer chamber 102. In one embodiment, the pumping system includes a roughing pump coupled in tandem to a turbomolecular or a cryogenic pump.

The process chambers 104 are typically bolted to the exterior of the transfer chamber 102. Examples of process chambers 104 that may be utilized include etch chambers, physical vapor deposition chambers, chemical vapor deposition chambers, ion implantation chambers, orientation chambers, lithography chambers and the like. Different process chambers 104 may be coupled to the transfer chamber 102 to provide a processing sequence necessary to form a predefined structure or feature upon the substrate surface.

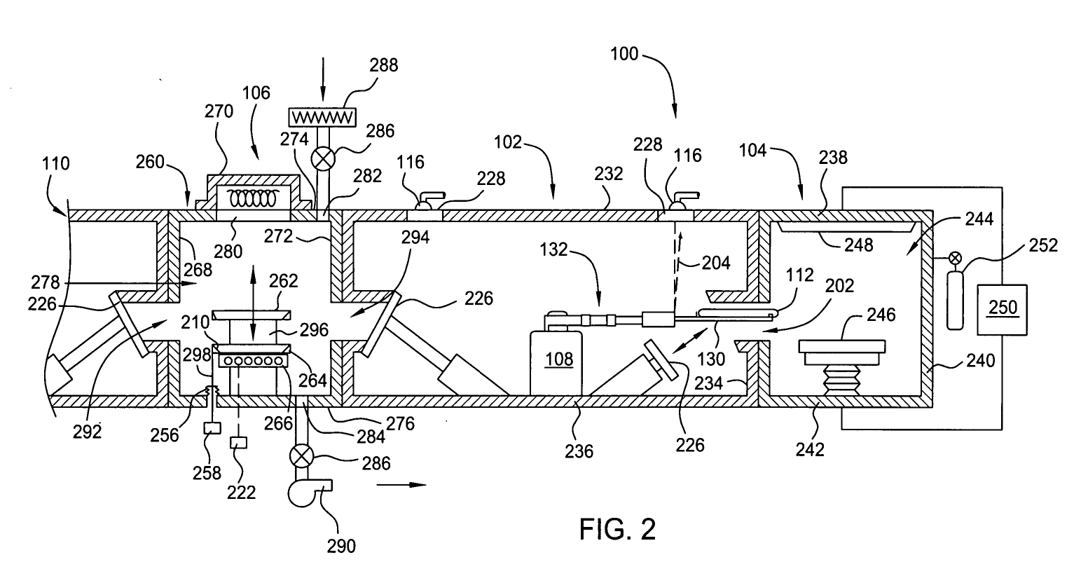

The load lock chambers 106 are generally coupled between the factory interface 110 and the transfer chamber 102. The load lock chambers 106 are generally used to facilitate transfer of the substrates between the vacuum environment of the transfer chamber 102 and the substantially ambient environment of the factory interface 110 without loss of vacuum within the transfer chamber 102. Each load lock chamber 106 is selectively isolated from the transfer chamber 102 and the factory interface 110 through the use of a slit valve 226 (see FIG. 2).

The substrate transfer robot 108 is generally disposed in the interior volume 128 of the transfer chamber 102 to facilitate transfer of the substrates 112 between the various chambers circumscribing the transfer chamber 102. The robot 108 may include one or more end effectors, such as a blade, utilized to support the substrate during transfer. The robot 108 may have two blades, each coupled to an independently controllable motor (known as a dual blade robot) or have two blades coupled to the robot 108 through a common linkage.

In one embodiment, the transfer robot 108 has a single end effector 130 coupled to the robot 108 by a (frog-leg) linkage 132. Generally, one or more sensors 116 of a centerfinding system are disposed proximate each of the processing chambers 104 to trigger data acquisition of the robot's operational parameters or metrics utilized in determining the position of the robot. The data may be used separately or in concert with the robot parameters to determine the reference position of a substrate 112 retained on the end effector 130. The data may be also be used separately or in concert with the robot parameters to monitor the performance of substrate transfer and/or placement, along with the condition of mechanisms associated and/or affecting substrate transfer within the system.

Generally, a bank of sensors 116 are disposed on or in the transfer chamber 102 proximate the passages coupling the transfer chamber 102 to the load lock chamber 106 and process chambers 104. The sensor bank 116 may comprise one or more sensors that are utilized to trigger data acquisition of robot metrics and/or substrate positional information. From the positional information of the substrate and the robot metrics acquired at the triggering events, the relative position between the substrate and the end effector may be resolved. Thus, by transferring the substrate from a predefined (e.g., known) target location to the end effector, the positional metrics of the robot may be resolved using the relative position relationship acquired using centerfind data, thereby allowing auto-calibration of the robot. Therefore, the robot may be taught to accurately move to taught locations with little or no operator interaction. As the calibration process may be performed while the system 100 is under vacuum, recalibration is much less intrusive compared to traditional calibration methods.

In an auto-diagnostic mode, positional error is monitored to determine trends in substrate transfer performance and/or changes in operational functionality of substrate movement devices. In one embodiment, positional error for a series of wafers (or end effector passes) may be monitored at a predefined sensor bank 116. The change in error over time is indicative of wear or other factors that cause a drift in wafer and/or end effector position. Examples of parameters which may be monitored using this type of auto-diagnostic routine include changes in factory interface robot performance, changes in transfer chamber robot performance, changes in substrate lift mechanisms, and change in system vibration, pressure and temperature, among others. Robot performance that may be monitored include gripper changes, bearing wear, changes in robot link backlash, changes in robot friction, encoder movement, encoder reading drift, changes in motor backlash, and changes in motor performance, among others. Changes in substrate lift mechanisms performance that may be monitored include wear of lift pins, where of lift pin holes and lift pin guides, wear and/or misalignment of lift pin actuation devices, wear and/or misalignment of substrate centering mechanisms, along with other devices and/or objects effecting wafer handoff. Changes in system vibration, pressure and temperature may be monitored to determine if their change may be correlated to drift or other change in positional error over time. Identification of what is causing the change in transfer characteristics may be determined empirically, such that information derived from an analysis of the change in positional error over time may be associated with a particular type or type of system malfunction, wear, change in environmental conditions, and the like.

In another embodiment of an auto-diagnostic routine, positional error determined between sensor banks 116 for wafer and/or end effector position may be monitored. The change in error is indicative activities or other events occurring between change of sensor states at each bank of sensors 116. Functional parameters such as those described above may be monitored using a change in error detected as a substrate is moved between sensor banks. Additionally, this type of monitoring may additionally be utilized to detect changes in substrate location due to environmental factors (changes in chamber geometry due to pressure and/or temperature and/or vibration, and/or slippage of the substrate in the end effectors, among others. For example, a change in pressure and/or temperature in one processing chamber may effect the relative position of the sensor bank to the robot center. In another example, thermal changes may change the length of robot linkages. In another example, a change in the deceleration and/or acceleration of the end effector may allow the substrate to shift position during transfer. It is contemplated that other system diagnostic information may be derived from the monitored change in position, either wafer to wafer, and/or sensor to senor bank during movement of a predetermined substrate.

Although the auto-diagnostic and auto-calibration sequences are described with reference to improving robotic motion within a semiconductor processing system, the invention may be used to improve the operation of other robot applications, including applications outside the field of semiconductor manufacture. Moreover, the term “wafer” and “substrate” are used interchangeably herein, and are representative of any workpiece that may be moved by a robot.

To facilitate control of the system 100 as described above, a controller 120 is coupled to the system 100. The controller 120 generally includes a CPU 122, memory 124 and support circuits 126. The CPU 122 may be one of any form of computer processor that can be used in industrial settings for controlling various chambers and subprocessors. The memory 124 is coupled to the CPU 122. The memory 124, or computer-readable medium, may be one or more of readily-available memory such as random access memory (RAM) read-only memory (ROM), floppy disk, hard drive, device buffer or any other form of digital storage, local or remote. The support circuits 126 are coupled to the CPU 122 for supporting the processor in a conventional manner. These circuits 126 may include cache, power supplies, clock circuits, input-output circuitry, subsystems and the like.

FIG. 2 depicts a sectional view of the system 100 illustrating the transfer chamber 102 having one of the load lock chambers 106 and one of the process chambers 104 coupled thereto. The illustrative process chamber 104 generally includes a bottom 242, sidewalls 240 and lid 238 that enclose a process volume 244. In one embodiment, the process chamber 104 may be a PVD chamber. A pedestal 246 is disposed in the process volume 244 and generally supports the substrate 112 during processing. A target 248 is coupled to the lid 238 and is biased by a power source 250. A gas supply 252 is coupled to the process chamber 104 and supplies process and other gases to the process volume 244. The supply 252 provides a process gas such as argon from which a plasma is formed. Ions from the plasma collide against the target 248, removing material that is then deposited on the substrate 112. PVD and other process chambers which may benefit from the invention are available from Applied Materials, Inc., of Santa Clara, Calif.

The illustrative load lock chamber 106 generally includes a chamber body 260, a first lift ring (substrate holder) 262, a second lift ring 264, a temperature control pedestal 266 and an optional heater module 270. The chamber body 260 is preferably fabricated from a singular body of material such as aluminum. The chamber body 260 includes a first side wall 268, a second side wall 272, a top 274 and a bottom 276 that define a chamber volume 278. A window 280, typically comprised of quartz, is disposed in the top 274 of the chamber body 260 and is at least partially covered by the heater module 270.

The atmosphere of the chamber volume 278 is controlled so that it may be selectively evacuated or vented to substantially match the environments of the transfer chamber 102 and the factory interface 110. Generally, the chamber body 260 includes a vent passage 282 and a pump passage 284. Typically, the vent passage 282 and the pump passage 284 are positioned at opposite ends of the chamber body 260 to induce laminar flow within the chamber volume 278 during venting and evacuation to minimize particulate contamination. In one embodiment, the vent passage 282 is disposed through the top 274 of the chamber body 260 while the pump passage 284 is disposed through the bottom 276 of the chamber body 260. Valves 286 are coupled to the respective passages 282, 284 to selectively allow flow into and out of the chamber volume 278. Alternatively, the passages 282, 284 may be positioned at opposite ends of one of the chamber walls, or on opposing or adjacent walls.

In one embodiment, the vent passage 282 is coupled to a high efficiency air filter 288 such as available from Camfil Farr, of Riverdale, N.J. The pump passage 284 is coupled to a point-of-use pump 290 such as available from Alcatel, headquartered in Paris, France. The point-of-use pump 290 has low vibration generation to minimize the disturbance of the substrates 112 positioned within the load lock chamber 106 while promoting pump-down efficiency and time by minimizing the fluid path between the chamber 106 and pump 290 to generally less than three feet.

A first loading port 292 is disposed in the first wall 268 of the chamber body 260 to allow substrates 112 to be transferred between the load lock chamber 106 and the factory interface 110. A slit valves 226 selectively seals the first loading port 292 to isolate the load lock chamber 106 from the factory interface 110. A second loading port 294 is disposed in the second wall 272 of the chamber body 260 to allow substrates 112 to be transferred between the load lock chamber 106 and the transfer chamber 102. Another slit valve 226 selectively seals the second loading port 294 to isolate the load lock chamber 106 from the vacuum environment of the transfer chamber 102. One slit valve that may be used to advantage is described in U.S. Pat. No. 5,226,632, issued Jul. 13, 1993 to Tepman et al., which is hereby incorporated by reference in its entirety.

Generally, the first lift ring 262 is concentrically coupled to (i.e., stacked on top of) the second lift ring 264 that is disposed above the chamber bottom 276. The lift rings 262 and 264 are generally mounted to a hoop 296 that is coupled to a shaft 298 that extends through the bottom 276 of the chamber body 260. Typically, each lift ring 262, 264 is configured to retain one substrate. The shaft 298 is coupled to a lift mechanism 258 that controls the elevation of the lift rings 262 and 264 within the chamber body 260. A bellows 256 is generally disposed around the shaft 298 to prevent leakage from or into the body 260.

Typically, the first lift ring 262 is utilized to hold an unprocessed substrate while the second lift ring 264 is utilized to hold a processed substrate returning from the transfer chamber 102. The flow within the load lock chamber 106 during venting and evacuation is substantially laminar due to the position of the vent passage 282 and pump passage 284 and is configured to minimize particulate contamination. The processed substrate disposed in the second lift ring 264 may be lowered into close proximately to, or in contact with, the temperature control pedestal 266. The temperature control pedestal 266 is coupled to a heat transfer system 222 that circulates a heat transfer fluid through passages formed in the pedestal 266. In one embodiment, the temperature control pedestal 266 rapidly cools to the substrate while under vacuum, thereby reducing the chance of condensation on the substrate after the chamber volume is vented to allow transfer of the substrate to the factory interface. One load lock chamber that may be adapted to benefit from the invention is described in U.S. Pat. No. 6,558,509, filed May 6, 2003 to Kraus et al., and is hereby incorporated by reference in its entirety.

Generally, the transfer chamber 102 has a bottom 236, sidewalls 234 and lid 232. The transfer robot 108 is generally disposed on the bottom 236 of the transfer chamber 102. A first port 202 is formed through the sidewall 234 of the transfer chamber 102 to facilitate transfer of a substrate by the transfer robot 108 between the process chamber 104 and the interior of the process chamber 104. The first port 202 is selectively sealed by a slit valve 226 to isolate the transfer chamber 102 from the process chamber 104. The slit valve 226 is generally moved to an open position as shown in FIG. 2 to allow transfer of the substrate between the chambers.

The lid 232 of the transfer chamber 102 generally includes windows 228 disposed proximate the ports 202, 294. The sensors 116 are generally disposed on or near the window 228 so that the sensors 116 may view a portion of the robot 108 and the substrate 112 as the substrate passes through a respective port 202, 294. The window 228 may be fabricated of quartz or other material that does not substantially interfere with the detection mechanism of the sensor 116, for example, a beam of light emitted and reflected back to the sensor 116 through the window 228. In another embodiment, the sensor 116 may emit a beam through the window 228 to a second sensor positioned on the exterior side of a second window disposed in the bottom 236 of the chamber 102 (second sensor and second window not shown). It is also contemplated that sensors 116 of the centerfinding system may also be disposed in the factory interface 110, the process chamber 104 or in the load lock chamber 106.

The sensor 116 is generally disposed on the exterior of the window 228 so that the sensor 116 is isolated from the environment of the transfer chamber 102. Alternatively, other positions of the sensor 116 may be utilized including those within the chamber 102 as long as the sensor 116 may be periodically tripped by motion of the robot 108 or substrate 112 therethrough. The sensor 116 is coupled to the controller 120 and is configured to record one or more robot or substrate metrics at each chance in sensor state. The sensor 116 may include a separate emitting and receiving unit or may be self-contained such as “thru-beam” and “reflective” sensors. The sensor 116 may be an optical sensor, a proximity sensor, mechanical limit switch, Hall-effect, reed switches or other type of detection mechanism suitable for detecting the presence of the robot 108 or the substrate.

In one embodiment, the sensor 116 comprises an optical emitter and receiver disposed on the exterior of the transfer chamber. One sensor suitable for use is available from Banner Engineering Corporation, located in Minneapolis, Minn. The sensor 116 is positioned such that the robot 108 or substrate 112 interrupts a signal from the sensor, such as a beam 204 of light. The interruption and return to an uninterrupted state of the beam 204 causes a change in state of the sensor 116. For example, the sensor 116 may have a 4 to 20 ma output, where the sensor 116 outputs a 4 ma in the uninterrupted state while the sensor outputs 20 ma in the interrupted state. Sensors with other outputs may be utilized to signal the change in sensor state.

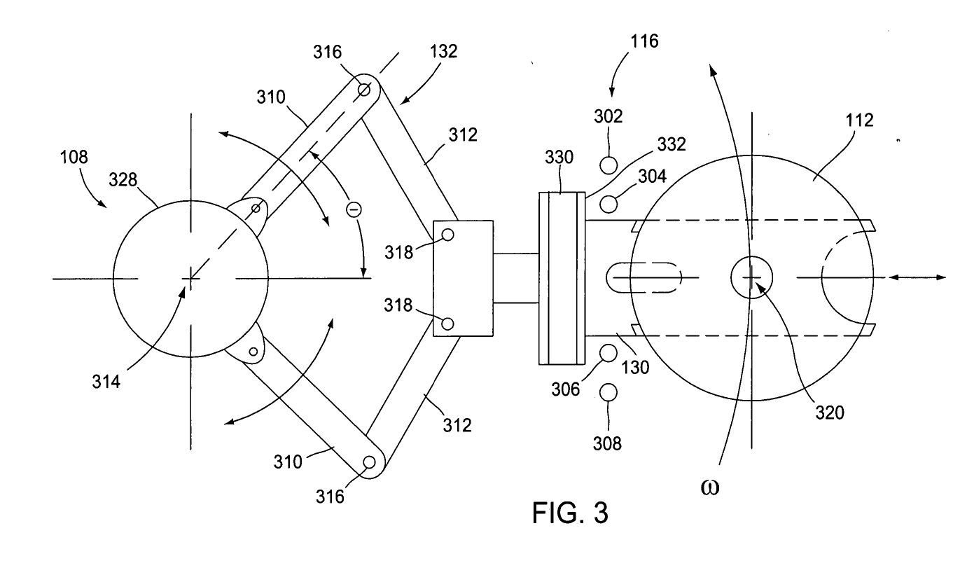

FIG. 3 depicts a plan view of one embodiment of the transfer robot 108. The transfer robot 108 generally comprises a robot body 328 that is coupled by the linkage 132 to the end effector 130 that supports the substrate 112. In one embodiment, the linkage 132 has a frog-leg configuration. Other configurations for the linkage 132, for example, a polar configuration may be alternatively utilized. The linkage 132 generally includes two wings 310 coupled at an elbow 316 to two arms 312. Each wing 310 is additionally coupled to an electric motor (not shown) concentrically stacked within the robot body 328. Each arm 312 is coupled by a bushing 318 to a wrist 330. The wrist 330 couples the linkage 132 to the end effector 130. Typically, the linkage 132 is fabricated from aluminum, however, materials having sufficient strength and smaller coefficients of thermal expansion, for example, titanium, stainless steel or a ceramic such as titanium-doped alumina, may also be utilized.

At ambient temperatures, each wing 310 has a length “A”, each arm 312 has a length “B”, half the distance between the bushings 318 on the wrist 330 has a length “C” and a distance “D” is defined between the bushing 318 and a center point 320 of the end effector 130. A reach “R” of the robot is defined as a distance between the center point 320 of the end effector 130 and a center 314 of the robot along a line “T”. Each wing 310 makes an angle θ with the line T.

Each wing 310 is independently controlled by one of the concentrically stacked motors. When the motors rotate in the same direction, the end effector 130 is rotated at an angle co about the center 314 of the robot body 328 at a constant radius. When both of the motors are rotated in opposite directions, the linkage 132 accordingly expands or contracts, thus moving the end effector 130 radially inward or outward along T in reference to the center 314 of the robot 108. Of course, the robot 108 is capable of a hybrid motion resulting from combining the radially and rotational motions simultaneously. As the substrate 112 is moved by the transfer robot 108, the sensor 116 detects the substrate or a portion of the robot upon reaching a predetermined position, for example, a position proximate the port 202.

In one embodiment, the sensor 116 comprises a bank of sensors, for example four sensors, that may be tripped by different portions of the substrate and/or robot to capture a plurality of data sets during a single pass of the robot 108. For example, an edge 332 of the wrist 330 of the robot 108 passing through the beam 204 causes the change of state of a first sensor 302 and a second sensor 304 while the substrate causes the change of state of the first sensor 302, the second sensor 304, a third sensor 306 and a fourth sensor 308. Although the invention is described as having the substrate 112 activate the sensors 302, 304, 306 and 308, the sensors may be activated by the wrist 330 or other components of the robot 108. It is additionally contemplated that the sensor 116 may comprised a single sensor, or a bank of sensors two or more sensors, and that the sensor(s) may be positioned to changes state in response to passage of the substrate or portion of the robot. Generally, the sensors are configured to provide at least three sensor state changes per substrate pass.

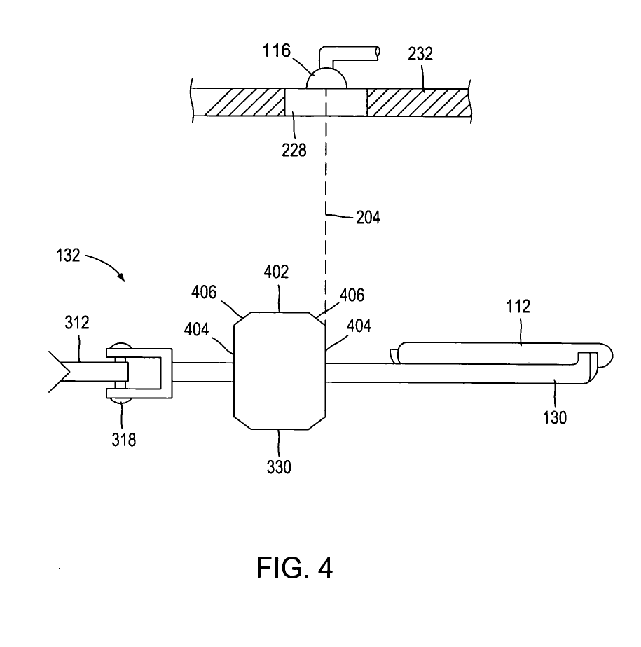

FIG. 4 depicts one embodiment of the wrist 330 of the robot. The wrist 330 of the robot is configured to have a flat upper surface 402 and sides 404 that are generally disposed at right angles to one another. The interface between the sides 404 and upper surface 402 generally has a sharp edge or chamfer 406 to reduce the amount of light scattering by the beam 204 of the sensor 116. The sharp edge or chamfered transition 406 between the upper surface 402 and the sides 404 provides a crisp change in sensor state which enhances the accuracy of the data acquisition if positional metrics of the end effector relative to the sensors 116 is desired.

Returning to FIG. 3, as the substrate 112 passes through one or more of the sensors 116, the sensors are changed from a blocked state to an unblocked state or vice versa. The change of the sensor state generally corresponds to the substrate 112 (or robot 108) being in a predetermined position relative to the sensor 116. Each time the robot 108 passes through any one of these predetermined positions, the robot metrics at the time of the event are recorded in the memory 124 of the controller 120. The robot metrics recorded at each event generally includes the sensor number, the sensor state (either blocked or unblocked), the current position of each of the two robot motors, the velocity of the two robot motors and a time stamp. Utilizing the robot metrics recorded at three events, the controller 120 can resolve an actual position the substrate 112 positioned on the end effector 130. Generally, the center position of the substrate 112 may be resolved utilizing data corresponding to three events that define the perimeter of the substrate 112. The controller 120 utilizes the center position data to resolve the relative position of the substrate and the end effector 130 (or other reference point) of the robot 108. The sensors 116 may also be utilized to acquire positional data of the end effector 130 to determine the position of the robot relative to the center position of the substrate 112. The substrate center information may be used along or in concert with the end effector 130 position information. Additionally, by comparing the actual (i.e., sensed) location of the end effector and the expected (i.e., taught or programmed) position of the end effector, the motion of the robot may be corrected in real time or over a sample period to correct for motor drift, bearing wear, linkage or motor backlash, thermal expansion or other robot error.

Thus, utilizing substrate center information obtained by the centerfinding sensors 116 corresponding to the position of the substrate 112 (or reference substrate as described below) retrieved by the robot from a predefined position, the substrate center information may be utilized to teach the robot how to arrive at the predefined position. It is contemplated in some alternative embodiments that the placement of the substrate in the predefined position may be realized by manually placing (aligning) of the substrate in the predefined position, mechanically aligning the substrate at the predefined position, mechanically aligning the substrate on the blade, or through an iterative process of passing the substrate through the sensor bank while moving the substrate around on the end effector, all as further described below.

The method for determining the position of the robot is generally stored in the memory 124, typically as software and software routine. Software routine may also be stored and/or executed by a second CPU (not shown) that is remotely located from the system or being controlled by the CPU.

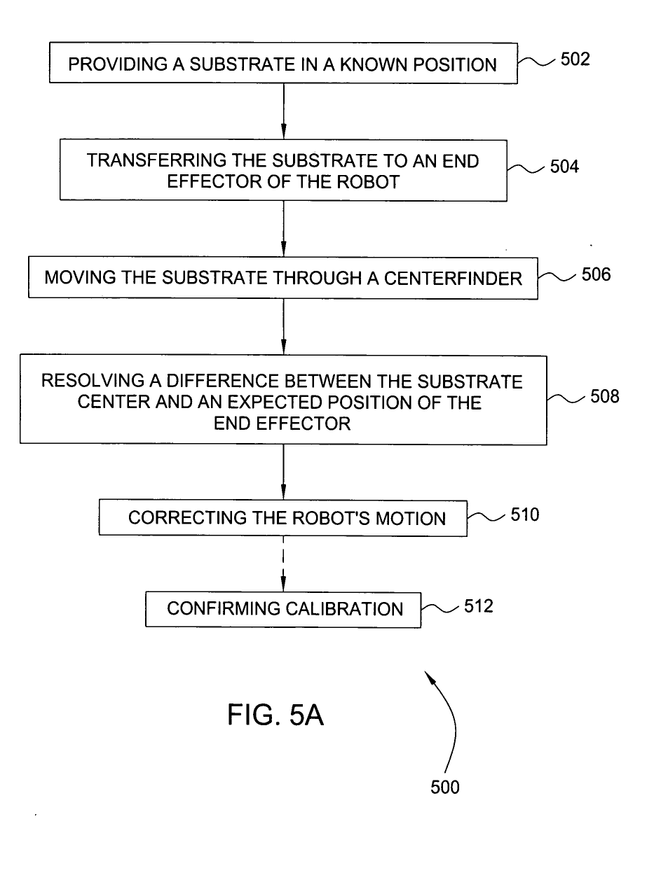

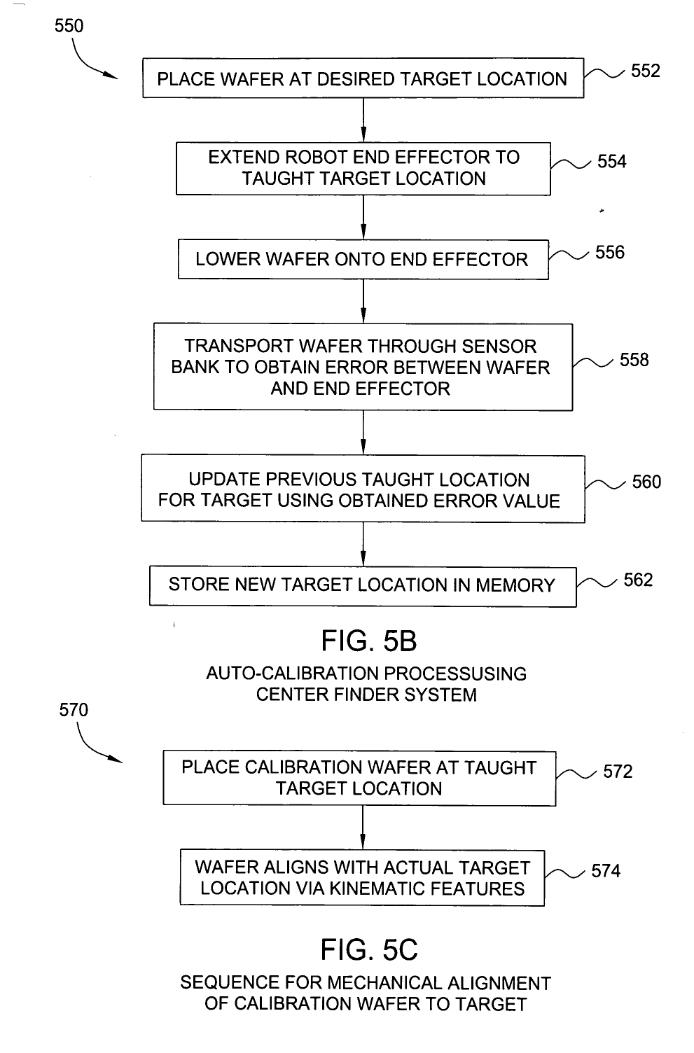

FIG. 5A depicts a flow diagram of one embodiment of a method 500 for determining the position of the robot. The method 500 begins at step 502 by placing a substrate in a known (e.g., predefined) position.

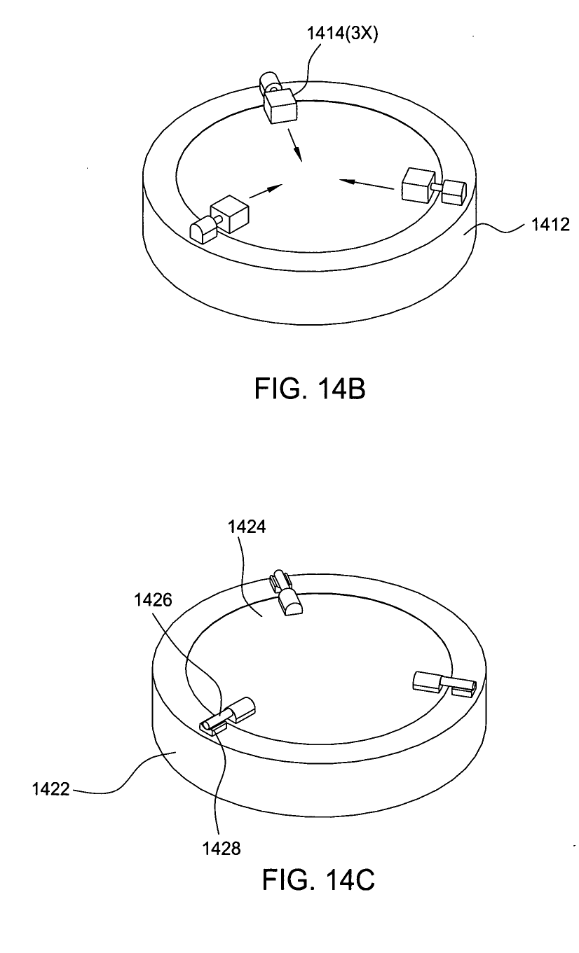

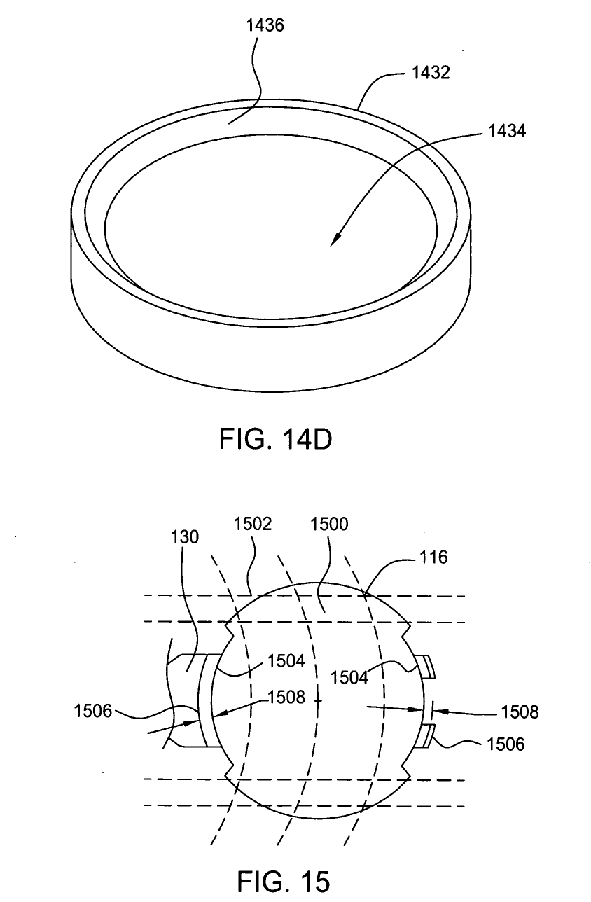

The method 500 begins at step 502 by providing a substrate in a known position. The substrate may be provided in a known position at step 502 by manually centering a substrate on a support or other object within the range of motion of the robot and able to exchange the substrate positioned thereon with the robot. Alternatively, the substrate may be placed on a substrate support and kinematically moved into a known position, for example, on an aligner or other device that mechanically centers the substrate as discussed below with reference to FIGS. 14A-D.

At step 504, the substrate 112 is transferred to the end effector 130 of the robot 108. The substrate supported on the end effector is then moved through the centerfinder (e.g., the sensors 116) to acquire a set of metrics indicative of the substrate's position relative to the end effector. Generally, the robot metrics are recorded in response to a change of state (i.e., tripping of one or more of the sensors 116), as the robot 108 passes the sensor 116 while moving the substrate through the transfer chamber 102. The robot metrics are recorded as the edge of the substrate trigger the sensors as the substrate passes the sensor bank. The data points from the perimeter of the substrate 112 are used to triangulate the center position of the substrate.

In one embodiment, the centerfind algorithm is performed by converting each latched substrate edge position to an X,Y co-ordinate system, where 0,0 is at the center of the end effector 130, and Y extends out away from the robot center. Next, the list of points (from the latched edge position) are examined and points that are significantly not co-circular with the other points are removed from consideration. Dropped points may be due, for example, points being latched as a notch or flat present in some substrates 112 passes one of the sensors 116. Each of the remaining points are grouped into combinations of 3 points to define both a triangle and a circle. If the area of the triangle is very small, that combination of points will be very error sensitive for circle calculation, and is excluded from further consideration. Next, the center and radius is calculated for the circle defined by each remaining combination of 3 points. The X and Y coordinates for the centers of all such circles with a radius within an acceptable range are then averaged to get the X and Y center of the substrate 112.

The X and Y substrate data is compared to X and Y end effector positional obtained from the robot metrics recorded at the triggering events. If the substrate is correctly centered on the robot, the X and Y offset (dx, dy) between the substrate and end effector is zero. A non-zero dx, dy represents an offset between the substrate 112 and the center of the end effector, which is the indicative of robot positional error. The dx, dy, (e.g., substrate/robot offset) which is resolved at step 506 to correct the robot motion so that the end effector/substrate's center to center match when substrate handoff is made at the predefined position. Once the dx and dy offset is resolved at step 508, the motion algorithm of the robot is corrected at step 510 to complete a robot calibration process.

Optionally, steps 502, 504, 506 and 508 may be repeated at step 512 to confirm that the calibration was successful, or to iteratively increase the accuracy of the robot motion. Alternatively, step 512 may be periodically or at each instant that a substrate travels past the sensors 116 to continually monitor and correct robot motion, such as in an auto-diagnostic mode as further described below.

In another embodiment of the invention, a centering device may be utilized to position the substrate in a predefined position at step 502. For example, a substrate-centering pocket to be provided on at least one of the chamber lift, cluster tool robot end effector or dedicated substrate centering device. The methods of centerfinding in the cluster tool may also be utilized. If the robot end effector is utilized to center the substrate thereon, the steps 502 and 504 may be combined and/or reversed. The assumption is made that the robot has “sniffing” capabilities (i.e., substrate edge finding) and can mechanically center the substrate using the clamp mechanism. The basic approach is to mechanically center the substrate with respect to the end effector and target, and then determine its location using the existing centerfinder systems.

As previously discussed, many chamber types do already include centering lift rings or pockets to center a substrate in the event that the substrate is severely misplaced. For example, the load lock chamber 106 of FIG. 3 may includes centering device 210 on the lift ring 264 that transfers the substrate from the end effector 130 to the temperature control pedestal 266 disposed in the load lock chamber 106.

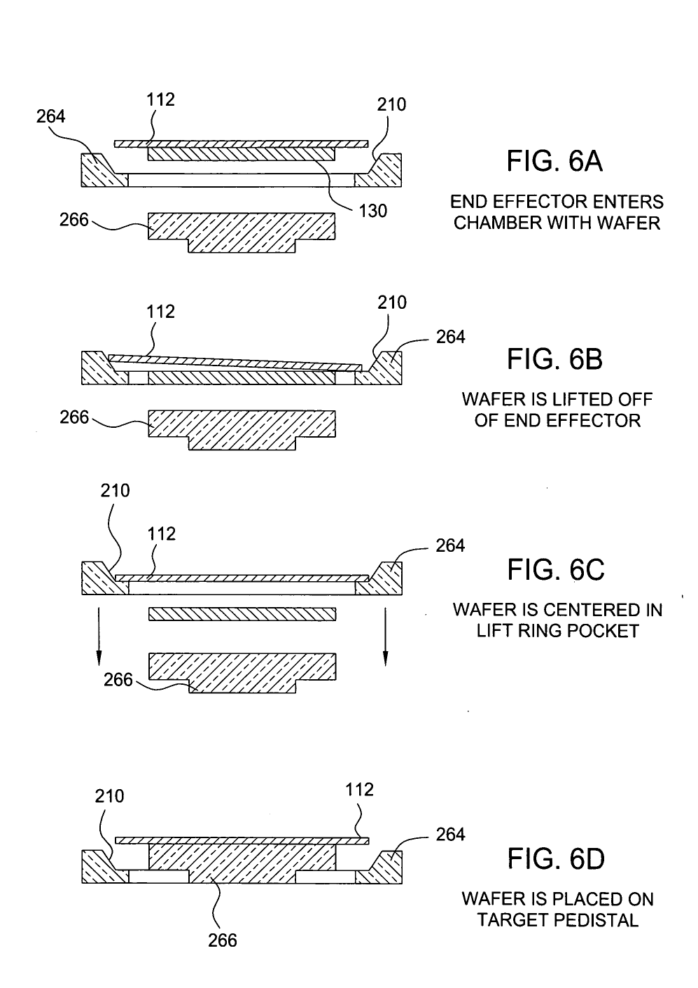

As depicted in the schematic of FIG. 6, the lift ring 264 includes a centering device 210 in the form of a plurality of fins that flare radially inwards towards the center of the temperature control pedestal 266. Thus, as the substrate 112 is lifted by the lift ring, as shown in illustration (B), the substrate, when misaligned, contacts at least one of the fins of the centering device 210, which guide the substrate into a centered position, as shown in illustration (C). In illustration (A) of FIG. 6, the substrate 112 is positioned at the target position by the end effector. As the substrate is then lowered onto the temperature control pedestal, the substrate is centered in a predefined position with respect to the chamber, as shown in illustration (D). When the substrate is lifted again by the lift ring, the substrate is transferred from the predefined position to the end effector. It is contemplated that the centering device 210 or similar substrate alignment mechanism, active or passive, may be incorporated in other substrate supports within the system 100, including stand-alone alignment pedestals. It is also contemplated that the centering device 210 may be incorporated into the end effector 130.

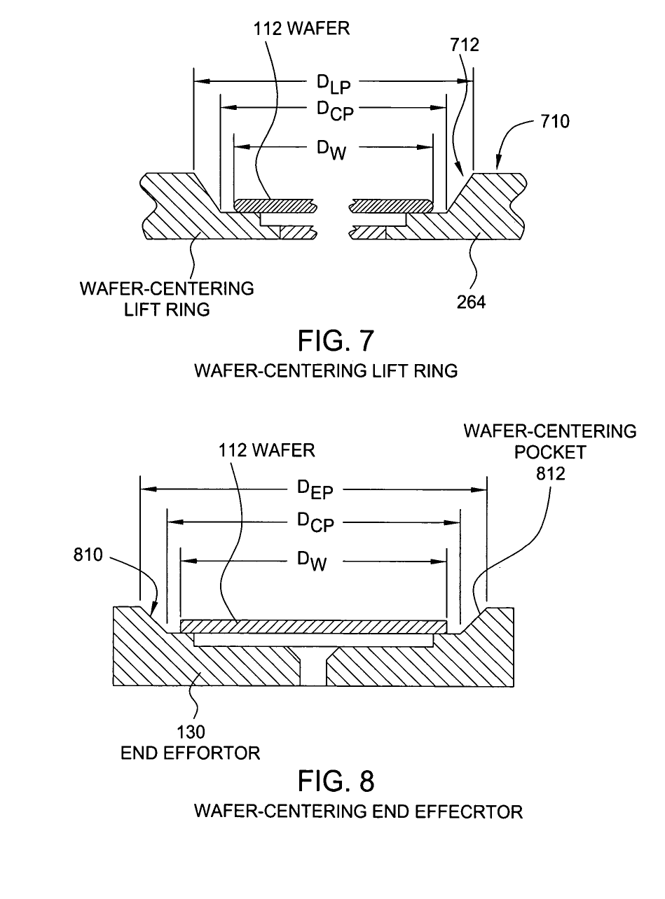

One embodiment of a lift ring 264 with a substrate-centering device 710 is shown in FIG. 7. The device 710 includes a centering pocket 712 having flared walls. The centering pocket diameter, D_{CP} is sufficiently larger than the substrate diameter, D_{W}, such that it does not affect the position of the substrate 112 in normal system operation. The outer-most diameter of the lift pocket, D_{LP}, is sized large enough to center a substrate placed at the default chamber location.

Similarly, each cluster tool robot end effector 130 also includes a substrate-centering pocket 812 as shown in FIG. 8. Again, the centering pocket diameter, D_{CP}, is sufficiently larger than the substrate diameter, D_{W}, such that it does not affect the position of the substrate in normal system operation. The outer-most diameter of the end effector pocket, D_{EP}, is sized large enough to handle the error between the end effector and a substrate placed at the default chamber location.

FIG. 5B depicts a flow diagram another embodiment of a method 550 for determining a position of a robot. Assuming that the centerfinding system has been calibrated, the sensors 116 can be used to determine the error between a wafer on the end effector and the center of the end effector pocket. To teach the robot end effector to a target location, the wafer must first be physically located at the desired location at step 552. The robot is extended to the desired location at step 554 and then picks the wafer up at step 556. At step 558, the robot transports the substrate through a centerfinder sensor bank at step 504. The wafer correction system is then used to establish the error of the wafer position with respect to the end effector, which is also the same as the error between the actual target location and current taught target location at step 560. Using this information, the robot calibration values for the target location are updated at step 562, such that the taught location is then coincident with the actual target location. The proposed semi-automatic teaching method removes all subjectivity from the calibration process.

The described process also automates the process, with the exception of the first step of initially placing the calibration wafer at the desired target location. There are a number of ways to automate this step as well, resulting in a fully automatic calibration process. A fully automated calibration method is beneficial, as it can be performed without removing the chamber lids or venting the system to atmospheric pressure. The basic steps for automating a calibration process 570 are illustrated in FIG. 5C. The process 570 includes first placing a wafer or calibration wafer at a taught target location at step 572, and kinematically aligning the wafer with the actual target location at step 574. It is also contemplated that the wafer may be passively aligned at the target location.

These two additions to the current system hardware, a substrate-centering end effector and lift ring, can perform the required functions when used in conjunction with the existing centerfinder systems. The process by which this is accomplished is described in greater detail below.

Robot-To-Load Lock Calibration

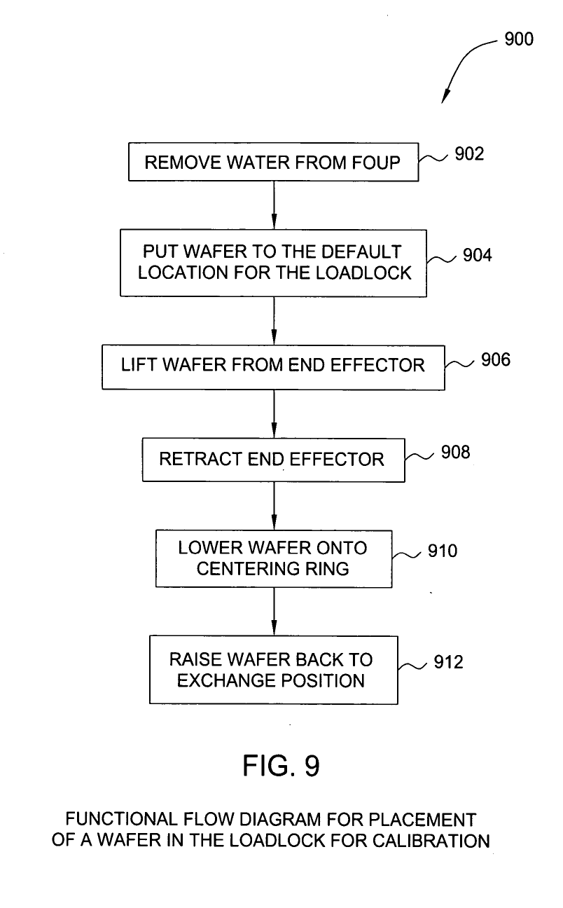

It is contemplated that the entire calibration may be automated by the present invention. In one embodiment, the robot, load lock substrate lift fins, and/or a centering feature located on the temperature control pedestal perform the function of positioning the substrate automatically in a predefined position as illustrated in the flow diagram illustrated in FIG. 9.

FIG. 9 is a functional flow diagram for placement of a wafer in the loadlock for calibration using a method 900. The method 900 begins at step 902 by removing a wafer from a FOUP on the end effector of the robot. At step 904, the robot moves the substrate to a predefined default location (e.g., target location). The default location is a location having a kinematic or passive alignment mechanism for positioning the wafer in a known position with respect to the end effector. At step 906, the wafer is lifted from the end effector. The end effector is retracted clear of the wafer at step 908. At step 910, the wafer is lowered onto the centering device. At step 912, the wafer is raised back to the exchange position from the centering device. In the raised position, the wafer is positioned in a predefined position, from which the actual position of the substrate may be determined using the substrate as a reference.

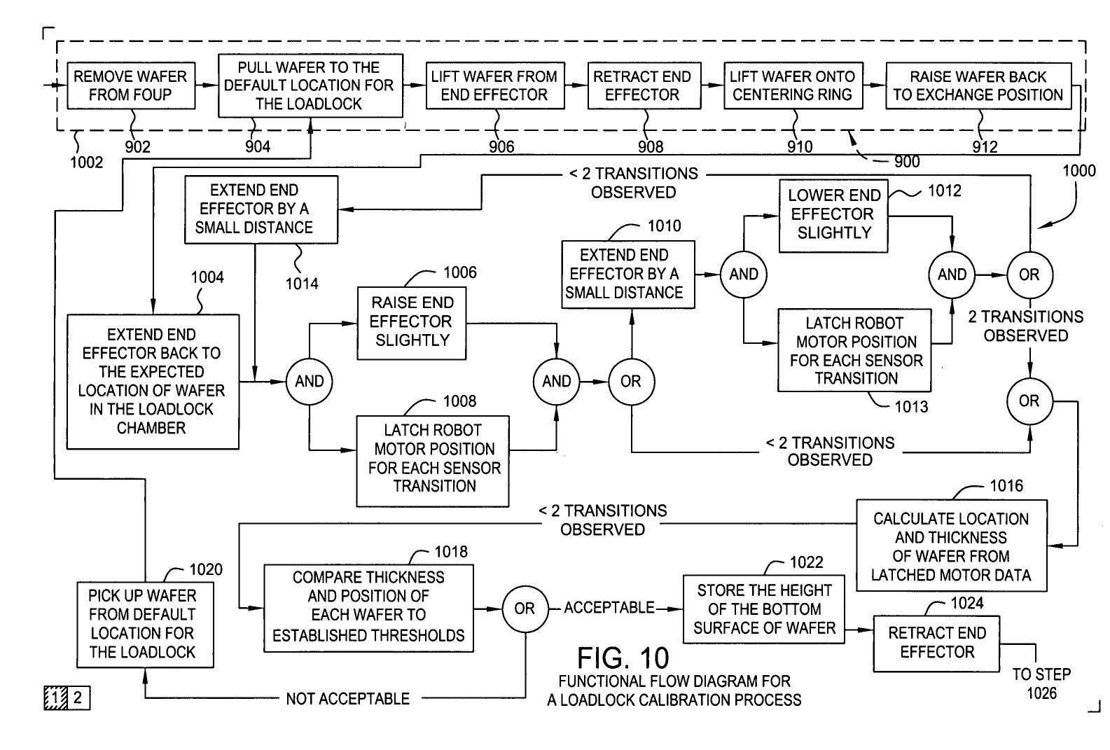

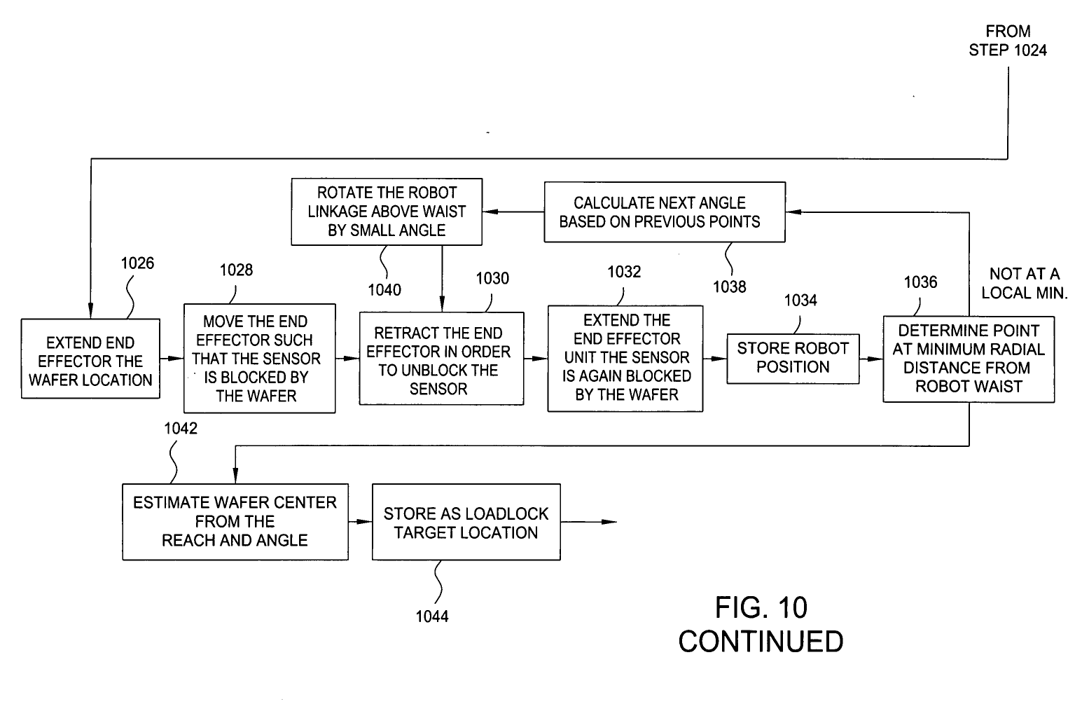

With the process of initially locating a substrate in the load lock now automated, the remainder of the procedure is much the same as described in FIG. 5A. However, the entire sequence can now be automated as illustrated in FIG. 10.

FIG. 10 depicts a functional flow diagram for one embodiment of a loadlock calibration process 1000. The process 1000 begins at step 1002 wherein the wafer is positioned in a known location relative to the end effector. In the embodiment depicted in FIG. 10, step 1002 may be performed using the method 900 described above. At step 1004, the end effector is extended back to the target location of the wafer in the loadlock chamber over the centering device and receives the wafer. At step 1006, the end effector, having the substrate positioned thereon, is raised slightly to a position that changes the state of a sensor. At step 1008, the robot motor position is latched (i.e., stored in the memory of the controller) for each sensor transition (i.e., change of sensor state). If less than two sensor transitions are observed, the method 1000 proceeds to step 1010 where the end effector is extended by a small distance. At step 1012, the end effector is lowered slightly to change the state of at least one sensor. At step 1013, the position of the robot motor is latched for each sensor transition. If less than two transitions are observed, the method 1000 proceeds to step 1014, wherein the end effector is extended by a small distance. Steps 1006 and 1008 are then repeated.

If two sensor transitions are observed after steps 1008 or 1013, the method 1000 proceeds to step 1016 wherein the location and thickness of the wafer is calculated from the latched motor data. At step 1018, the calculated location and thickness of the wafer are compared to thickness and position thresholds for the wafer. If the calculated location and thickness are not acceptable, the method 1000 proceeds to step 1020, wherein the wafer is picked up from the default location on the loadlock on the end effector and moved to the default location for repositioning at step 1002. If the calculated location and thickness data is acceptable, the method 1000 proceeds to step 1022 where the controller stores the height of the bottom surface of the wafer. At step 1024, the end effector is retracted.

At step 1026, the end effector is extended with the wafer thereon to the wafer location. At step 1028, the end effector is moved such that at least one sensor is blocked by the wafer. At step 1030, the end effector is retracted in order to unblock the sensor. At step 1032, the end effector is moved so that a sensor once again blocked by the wafer. At step 1034, the robot motor position is latched. At step 1036, the radial distance or error of the expected robot extension and the actual robot extension needed to change the sensor state is determined. In one embodiment, the radial distance is the distance from the wrist moves from the expected position to a position where the edge of the wafer trips the sensor. Assuming that the robot extension required to trip the sensors has been increasing and the minimum radial distance has not been found, the method 1000 proceeds to step 1038, wherein the controller calculates an angle based on the previous wrist angle, such that the other points are not duplicated. At step 1040, the robot linkage is rotated about the wrist small angle. Following step 1040, steps 1030, 1032, 1034 and 1036 are repeated until either a predetermined number of data points are obtained, the minimum radial distance is found, or one of the wafers centerline or edge has been found. If the minimum radial extension is found at step 1036, the method proceeds to step 1042 where the controller estimates a wafer center from the minimum reach and angle. At step 1044, the robot target location is stored based on derived wafer center location. It is contemplated that this procedure may be performed using the other wafer to trip the sensors.

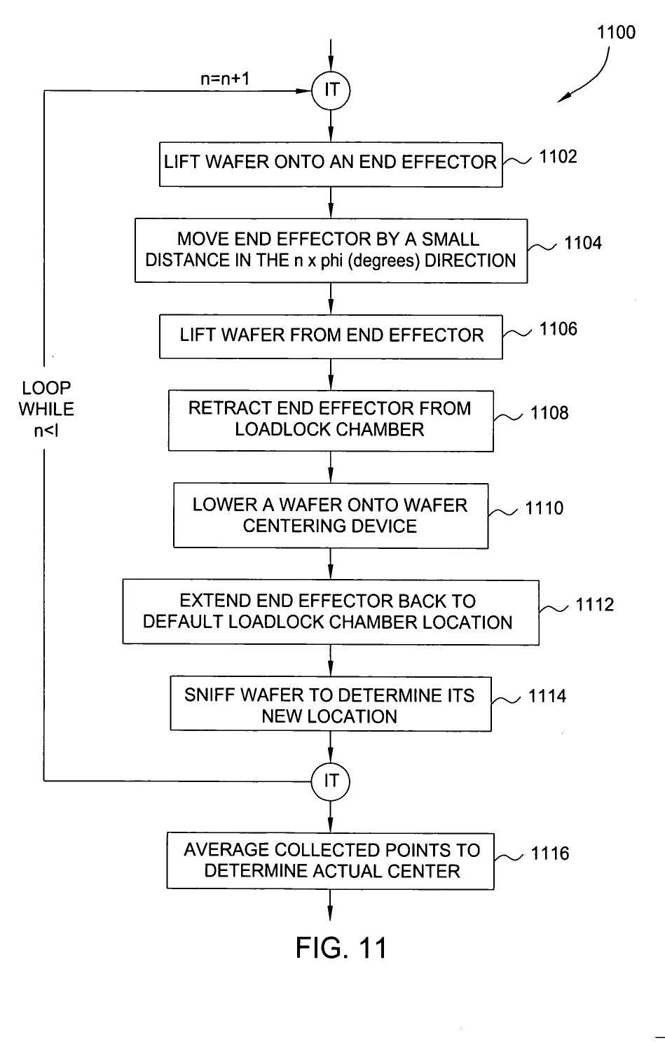

Since the substrate-centering pocket is slightly oversized, some amount of error will be introduced; however, iterating the handoff process as shown in FIG. 11 will reduce this error. In this approach, the robot end effector presents the substrate in a slightly different position each time it is placed. By sniffing each time after the placed substrate has been centered by the chamber lift, the variation in the correction value can be obtained. A number of techniques can then be used to convert this set of points into one location to which the robot is taught.

FIG. 11 depicts a functional diagram for averaging a position to reduce error using a method 1100. The method 1100 may be employed selectively when the substrate, kinematically and/or passively positioned in a known location, is transferred to the end effector.

The system 1100 begins at step 1102 by transferring the wafer onto the end effector. At step 1104, the end effector is moved a small distance. The distance moved by the end effector may be either an extension, rotation or both. At step 1106, the wafer is lifted from the end effector, and the end effector is retracted clear of the wafer at step 1108. At step 1110, the wafer is lowered to wafer centering device, such as a kinematic centering or passive centering device, which positions the substrate in a known location. At step 1112, the substrate is lifted and the end effector is extended back to the taught location to receive the wafer. At a sniffing step 1114, the wafer on the end effector is moved through one or more sensors to determine a relative position between the end effector and the wafer. The end effector is moved to an expected position which is proximate the sensors. The difference between the latching of the robot motors in response to the actual end effector position and the expected robot motor position is indicative of a movement or positional error. Steps 102 through 1114 are iteratively repeated a predetermined number of times to collect a plurality of data points indicative of the relative positions of the end effector and wafer. At step 1116, after the data points have been collected, an error between the taught location and the known wafer position is determined based on an average position errors derived from collected data.

Cluster Tool Robot-To-Load Lock Calibration

Another method of automating the cluster tool calibration is similar to that of the robot to load lock described above, with the robot having the ability to center a substrate with the clamping mechanism. However, the cluster tool robot does not initially know where a substrate is located on the end effector. The centerfinder system (e.g., the sensors 116) could be used to determine the substrate position. However, the centerfinder system must be calibrated prior to use. In order to calibrate the centerfinding system, a substrate must be centered on the end effector; but, a substrate cannot be centered on the end effector without the use of the centerfinder system.

Two methods are presented for calibrating the cluster tool. The first requires the centerfinder system to be calibrated first. Once the centerfinder is calibrated, it can then be used to calibrate the robot in a process similar to that proposed for calibrating in the previous section. In the second approach, the end effector is taught to the load lock first. Once taught to this position, a centered substrate can be removed from the load lock and used to calibrate the centerfinder system.

Centerfinder-First Approach

A special tool resembling an oversized substrate is loaded into the load lock by the robot, which is retrieved by the cluster tool robot and used to calibrate the centerfinder system. The diameter of the tool is matched to the pocket diameter of the end effector, such that the tool fits tightly in the pocket. Alternatively, a specially designed end effector can be used with some other kinematic mounting feature provided to interface with a centerfinder calibration tool. The oversized substrate approach is most likely the easiest to implement with the existing hardware. Once the centerfinding system is calibrated, the transfer chamber robot is then taught to the target locations in a manner similar to that presented for the load lock calibration.

Robot-First Approach

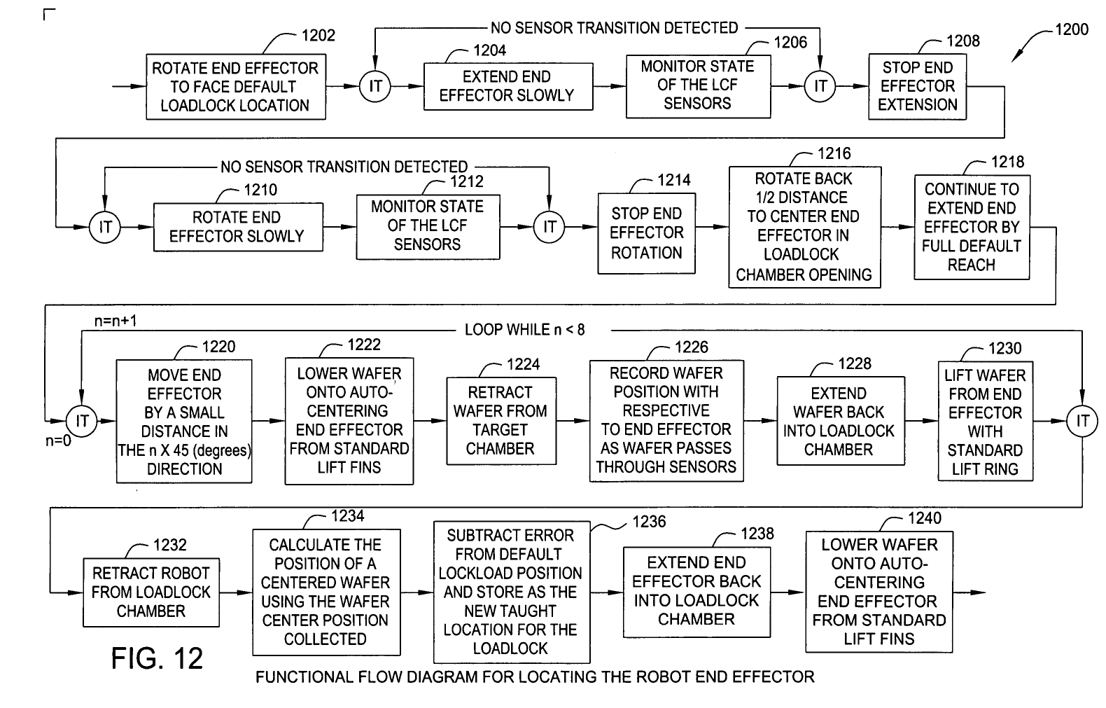

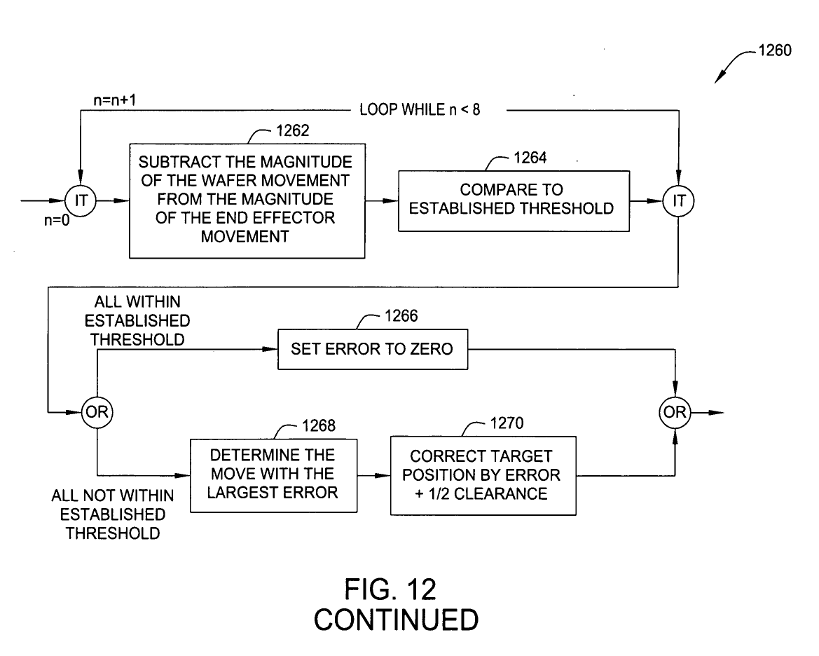

This approach is also similar to the load lock calibration process; however, a different method must be first used to locate the end effector (FIG. 12). The procedure begins with the assumption that a substrate has been placed in the center of the load lock by the robot. The cluster tool robot moves to the default location of the load lock, where a centered substrate is lowered onto the end effector. The substrate then slides into place in the substrate-centering pocket on the end effector. The robot retracts and uses the centerfinder sensors to determine the position of the substrate with respect to the sensors.

Since it is not yet calibrated, the centerfinder system cannot be used to determine if the substrate is in the center of the end effector; but it can be used to determine how much a substrate moves from one operation to the next. Using this basic principle, the transfer chamber robot iterates the pick and drop of the substrate in the load lock; retracting each time to determine how much the substrate has moved. During this initial process, the fins are used to lift the substrate from the end effector, but the substrate is not lowered onto the centering ring within the load lock. This first step is only required to locate the end effector with respect to the substrate.

FIG. 12 is a functional flow diagram for a method 1200 for locating the robotic end effector. The method 1200 begins at step 1202 by rotating the end effector to face a default loadlock location. At step 1204, the end effector is extended slowly, and the state of a bank of centerfind sensors are monitored at 1206. If no sensor transitions are detected, steps 1204, 1206 are repeated after a small end effector rotational displacement. At step 1208, the extension of the end effector is stopped in response to a detected sensor transmitter.

At step 1210, the end effector is rotated slowly while the state of the sensors is monitored at step 1212. If no sensor transition is detected, steps 1210 and 1212 are repeated. At step 1214, the rotation of the end effector is stopped.

At step 1216, the end effector is rotated one-half the distance to center the end effector in the loadlock chamber opening. At step 1218, the end effector is extended to reach the full default reach position.

At step 1220, the end effector is moved by a small distance. The distance may be either an extension, rotation or a combination of both extension and rotation. At step 1222, a wafer is lowered onto the end effector. At step 1224, the end effector is retracted from the target chamber. At step 1226, the wafer position is recorded with respect to the end effector as the wafer passes through the sensors. At step 1228, the wafer is extended back into the loadlock chamber, and the wafer is lifted from the end effector at step 1230. This process is iteratively repeated a predefined number of times, as described with reference to the method 1100, to further reduce the error in the robot position. In one embodiment, the end effector is rotated 45 degrees iteratively such that 8 data points are obtained from handoff position 360 degrees around the target position.

At step 1232, the robot is retracted from the loadlock chamber. At step 1234, the position of the centered wafer is calculated using the corrected wafer center points collected at step 1226. At step 1236, the calculated error from the default loadlock position is subtracted from the taught position of the end effector and stored as a new taught position for the loadlock. At step 1238, the end effector is extended back into the loadlock chamber. At step 1240, the wafer is lowered onto the end effector.

In one embodiment, step 1234 may be resolved using a method 1260. The method 1260 is performed during the method 1200 to ensure that the offset of the substrate relative to the end effector is within a predefined range or a threshold. The method 1260 begins at step 1262 by subtracting the magnitude of the wafer movement from the magnitude of end effector movement, which was determined at step 1226. At step 1264, the difference in magnitude is compared to a predefined or established threshold. If the movement difference is within an established threshold, the error is set to zero at step 1266. If not all of the differences are within the established threshold, the robot movement with the largest error is determined at step 1268. At step 1270, the target position is corrected by the error plus one half the clearance distance, wherein the clearance distance is the difference between the pocket size in a centering device and the diameter of the wafer.

Once the location of the substrate is known relative to the end effector, the process for calibrating the chamber positions is the same as the previously presented. The centerfinder system can either be calibrated using the same standard substrate used in the initial end effector location process, or it can be calibrated using a calibration tool once the robot teaching process is complete. In the later case, a specially designed calibration substrate can be automatically installed once the robot has been taught to load lock position.

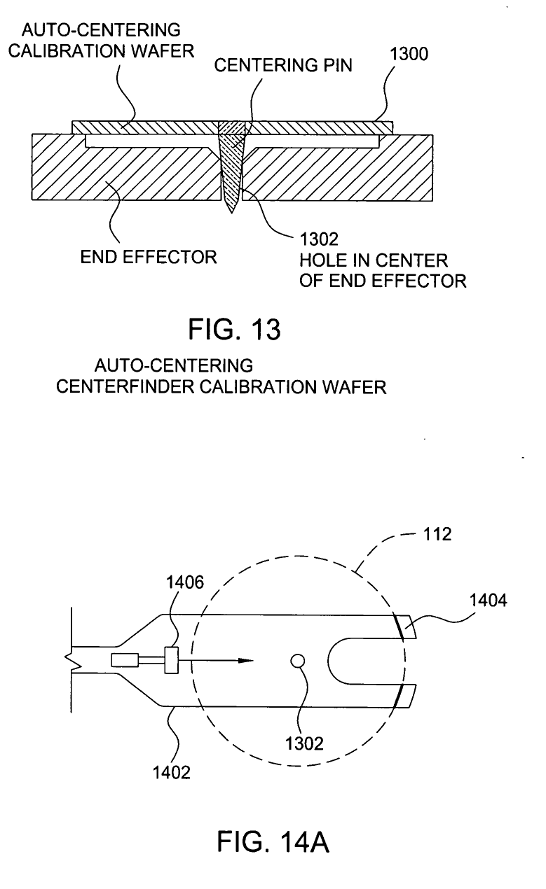

Once the end effector is taught to a load lock chamber using this technique, the centerfinder system itself must then be calibrated. The conventional approaches require the chamber to be vented to atmospheric pressure so that the chamber lid can be removed. However, once the end effector has been precisely taught to a load lock, it should be possible to pass a special centerfinder calibration substrate into the cluster tool without venting the system. The simplest approach identified uses a pinned substrate 1300 designed to interface with a hole 1302 in the center of the end effector (FIG. 13), which is currently used in the manual calibration process. If this simple approach proves to be insufficient, a more robust kinematic mounting alternative can be used; however, a specially designed end effector would most likely be required.

FIGS. 14A-D depict examples of devices suitable for aligning the substrate in a predefined position, thereby enhancing the calibration processes described above. In FIGS. 14A-B, kinematic devices are shown that mechanical move the substrate to the predefined position. For example, FIG. 14A depicts an end effector 1402 having a lip 1404 at a distal end and a pusher 1406 proximate the wrist of the end effector. The pusher 1406 may be actuated, for example by a pneumatic cylinder or solenoid, to force the substrate 112 (shown in phantom) against the lip 1404, thereby centering the substrate with respect to the end effector.

FIG. 14B depicts a substrate support 1412 having a plurality of pushers 1414 disposed around the circumference of the support 1412. The pushers 1414 may be actuated, for example by a pneumatic cylinder or solenoid, to center the substrate (not shown) on the support 1412. Lift pins have been omitted, here and in other embodiments, for the sake of brevity.

The substrate may alternatively be aligned by passive devices. For example, in FIG. 14C, a substrate support 1422 is configured to engage a calibration wafer 1424. The support 1422 and wafer 1424 include mating features that passively position the wafer 1424 relative to the support 1422. In the embodiment depicted in FIG. 14C, the substrate support 1422 includes a plurality of grooves 1428 that engage a respective pin 1426 extending from the calibration wafer 1424. It is contemplated that other mating features or geometry may be utilized to position the wafer 1424 in a predefined position relative to the support 1422.

FIG. 14D depicts another embodiment of a substrate support 1432 having a passive alignment mechanism. The support 1432 includes a substrate receiving pocket 1434 having flaring sidewalls 1436. The flaring sidewalls 1436 are configured to urge a misaligned substrate into a predefined position relative to the support 1432.

FIG. 15 is one embodiment of a calibration wafer 1500 configured to prevent error (i.e., movement of the substrate) introduced by features of the end effector during transfer between the substrate supporting component and the end effector. The calibration wafer 1500 itself must interface with the centerfinding sensors (sensing paths of which are shown by dashed lines), but must not be affected by the end effector pocket or lips 1506 in any way. Therefore, the calibration wafer 1500 has one or more perimeter sections 1502 for tripping the sensors 116 and one or more cutout sections 1504 designed such that there is adequate clearance 1508 between the sections 1504 and lips 1506 when it is placed onto the end effector. The calibration wafer may also possesses friction pads on the bottom surface, which make contact with the end effector to prevent sliding during transport.

Both the function of the passive and active centering devices can be verified using an interactive approach similar to the method described in FIG. 11. Once a calibration or process wafer is passively (or actively) centered by such a centering device, the operator may not be able to visual verify the alignment is correct. In order to detect misalignment errors in centering, such as total misalignment of the kinematic features, some form or verification that the centering process worked correctly is desirable. Therefore, once a wafer has been aligned to a target location by the centering device, the alignment can be verified by iteratively repeating pick and drop operations with small known offsets in various directions. Each time the wafer is placed at a slightly offset position, the alignment mechanism should re-align the wafer to the same location. If during the iterative process, the centerfinding system observes the wafer to be off by an amount larger than expected for a properly functioning centering device, then gross errors in the passive centering can be detected.

Another method for verifying the detect misalignment errors in centering may be practiced by handing off the substrate to the end effector where the end effector is offset by a small predefined offset in a known direction prior to accepting the substrate. The centerfinder should confirm that the substrate and end effector is misaligned by the predefined offset if the centering mechanism is functioning properly. If the centerfinding system observes the wafer to be off by an amount larger or in a different direction than expected for a properly functioning centering device, then gross errors in the centering can be detected.

Thus, a method for automated teaching of a robot disposed in a processing system having a sensor based, substrate centerfinder system is provided. In some embodiment, the invention includes locating the position of a robot end effector with respect to a target location, where a substrate located at the target location is retrieved and transported from the target location on a robot end effector, the location of a substrate with respect to the robot end effector is determined as the end effector passes the substrate through a plurality of sensors (e.g., centerfinder) during transport, the location of the end effector with respect to the sensors has been predetermined and the error between the center of the substrate and end effector is used to correct the taught location for the target from which the substrate was received. The location of the end effector may be predetermined through a calibration step wherein the calibration is performed by precisely aligning a device resembling a substrate to the end effector and the device is passed though the sensors to determine the location of the end effector itself. The substrate in the target location may be mechanically aligned such that the center of the substrate and center of the target location is coincident before the substrate transferred to the end effector.

In other embodiments, a method for teaching a robot may include locating the position of a robot end effector with respect to a substrate at a target location, where a substrate located near the target location is retrieved and transported from the target location on a robot end effector, the location of a substrate with respect to the robot end effector is determined as the end effector passes the substrate through a plurality of sensors during transport, the location of the end effector with respect to the sensors has been predetermined, and the error between the center of the substrate and end effector is used to continually monitor parameters indicating functional performance of the system. The functional parameter may include substrate movement prior to the hand-off, substrate movement during to the hand-off, substrate misalignment as a result of the previous hand-off, friction within the robotic arm, and backlash within the robotic arm among other functional parameters effecting repeatable robot motion.

Although the process of the present invention is discussed as being implemented as the software routine, some of the method steps disclosed herein may be performed in hardware as well as by itself or controller. As such, the invention may be implemented in software as executed upon a computer system in hardware as in applications, specific integrated circuit or other type of hardware implementation or a combination of software and hardware.

While the foregoing is directed to the preferred embodiment of the present invention, other and further embodiments of the invention may be devised without departing from the basic scope thereof, and the scope thereof is determined by the claims that follow.

1. A process for locating a position of a robot end effector, comprising:
retrieving a workpiece located at a target position with a robot end effector;
passing the workpiece disposed on the end effector through a plurality of sensors, wherein at least one of the sensors changes state in response to a position of at least one of the end effector or workpiece;
recording a metric of robot position associated with the sensor change of state;
determining an error between an expected metric of the end effector position and the recorded robot position metric; and
correcting a taught location of the robot for the target position.

2. The process of claim 1, wherein the step of determining the error further comprises:
determining a position of the robot end effector with respect to the workpiece.

3. The process of claim 1 further comprising:
mechanically aligning the workpiece with respect to the target position such that a center of the workpiece and a center of the target position is coincident before the workpiece is transferred to the end effector.

4. The process of claim 3, wherein the step of aligning the workpiece further comprises:
kinematically centering the workpiece at the target position.

5. The process of claim 3, wherein the step of aligning the workpiece further comprises:
passively centering the workpiece at the target position.

6. The process of claim 1, wherein the step of recording the metric of robot position further comprises:
latching a metric of robot motor position.

7. The process of claim 1, wherein the location of the end effector with respect to the sensors is predetermined through a calibration step.

8. The process of claim 7, wherein the calibration step further comprises:
precisely aligning a device resembling a workpiece on the end effector; and
passing the device through the sensors to determine the location of the end effector with respect to the sensors.

9. A process for monitoring a robotic transfer system, comprising:
detecting a first positional error in a robotic transfer system; and
comparing the first positional error to a second positional error in the robotic transfer system.

10. The process of claim 9, wherein the first positional error is determined at a first location and the second positional error is determined at a second location.

11. The process of claim 9, wherein the first positional error and the second positional error are determined at a single location at different times.

12. The process of claim 10, wherein the first positional error and the second positional error represent misalignment between a workpiece and a robotic end effector.

13. The process of claim 10, wherein the step of detecting the first positional error further comprises determining a misalignment between a first workpiece and a robotic end effector; and wherein the second positional error is a misalignment between a second workpiece and the robotic end effector.

14. The process of claim 9, wherein the step of detecting the first positional error further comprises:
detecting workpiece movement prior to hand-off.

15. The process of claim 9, wherein the step of detecting the first positional error further comprises:
detecting workpiece movement during a hand-off.

16. The process of claim 9, wherein the step of detecting the first positional error further comprises:
detecting workpiece misalignment as a result of a previous hand-off.

17. The process of claim 9, wherein the step of detecting the first positional error further comprises:
detecting friction within a robotic linkage.

18. The process of claim 9, wherein the step of detecting the first positional error further comprises:
detecting backlash within a robotic linkage.

19. The process of claim 9, wherein the step of detecting the first positional error further comprises:
detecting backlash within a robotic motor.

20. The process of claim 9, wherein the step of detecting the first positional error further comprises:
determining a position of a robot end effector with respect to a workpiece supported thereon in a semiconductor processing system.

21. The process of claim 20, wherein the step of determining the location of the workpiece with respect to the end effector further comprises:
recording a metric of robot position associated with a change of sensor state; and
determining the error between an expected metric of the end effector position from the recorded robot position metric.

22. The process of claim 21, wherein the step of recording the metric of robot position further comprises:
latching a metric of robot motor position.

23. The process of claim 9, wherein the step of detecting the first positional error further comprises:
detecting a change in at least one of temperature, pressure or vibration of a system in which the robotic transfer system is operating.

24. The process of claim 9 further comprising:
determining from the comparison of errors when preventative maintenance to the robotic transfer system will be necessary.

25. A process for monitoring a robotic transfer system, comprising:
passing the workpiece disposed on a robot end effector through a plurality of sensors, wherein one sensor changes state in response to a position of at least one of the end effector or workpiece;
determining the location of the workpiece with respect to the robot end effector using the information derived from the change in sensor state;
determining a first error between the center of the workpiece and the end effector; and
comparing the error to a previously determined error.

26. The process of claim 25 further comprising:
continually monitoring the error as a parameter indicating functional performance of the robotic transfer system.

27. The process of claim 26, wherein the step of determining the first error further comprises:
detecting wafer workpiece movement prior to hand-off.

28. The process of claim 26, wherein the step of determining the first error further comprises:
detecting workpiece movement during a hand-off.

29. The process of claim 26, wherein the step of determining the first error further comprises:
detecting workpiece misalignment as a result of a previous hand-off.

30. The process of claim 26, wherein the step of determining the first error further comprises:
detecting friction within a robotic linkage.

31. The process of claim 26, wherein the step of determining the first error further comprises:
detecting backlash within a robotic linkage.

32. The process of claim 26, wherein the step of determining the first error further comprises:
detecting backlash within a robotic motor.

33. The process of claim 25, wherein the first error is determined by determining a relative position of the robot end effector with respect to the workpiece.

34. The process of claim 25, wherein the step of determining the location of the workpiece with respect to the end effector further comprises:
recording a metric of robot position associated with the sensor change of state; and
determining the error between an expected metric of the end effector position from the recorded robot position metric.

35. The process of claim 34, wherein the step of recording the metric of robot position further comprises:
latching a metric of robot motor position.

36. The process of claim 25, wherein the previously determined error is associated with robotic transfer of the same workpiece as the error.

37. The process of claim 36, wherein the previously determined error is determine in response to a change in state of the sensors utilized to obtain the first error.

38. The process of claim 36, wherein the previously determined error is determine in response to a change in state of sensors different than the sensors utilized to obtain the first error.

39. The process of claim 25, wherein the previously determined error is associated with robotic transfer of a different workpiece.

40. The process of claim 39, wherein the previously determined error is determine in response to a change in state of the sensors utilized to obtain the first error.

41. The process of claim 39, wherein the previously determined error is determine in response to a change in state of sensors different than the sensors to obtain the first error.

42. A process for monitoring a robotic transfer system, comprising:
monitoring changes in positioning errors in a robotic transfer system.

43. The process of claim 42, wherein the step of monitoring further comprises:
monitoring a drift in robot position.

44. The process of claim 42, wherein the step of monitoring further comprises:
monitoring a change in workpiece placement over time.

45. The process of claim 42, wherein the step of monitoring further comprises:
monitoring a change in relative position of a workpiece to an end effector over time.

46. The process of claim 42 further comprising:
determining a state of workpiece transfer performance based on the monitored changes.

47. The process of claim 46, wherein the step of determining further comprises:
determining a change in robot performance.

48. The process of claim 46, wherein the step of determining further comprises:
determining a change in at least one of temperature or pressure within a substrate processing system that effects robot performance.

49. The process of claim 46, wherein the step of determining further comprises:
determining, from a trend in errors over time, a need for robot maintenance.

50. The process of claim 49, wherein the need for robot maintenance is determined when error is within operational tolerances.

51. The process of claim 42 further comprising:
determining positional errors in robot motion in a vacuum chamber.
